(19) United States
(12) Patent Application Publication
(10) Pub. No.: US 2023/0279297 A1
(43) Pub. Date: Sep. 7, 2023

(54) RECOVERY OF DILUENT FROM DILUTED BITUMEN

(71) Applicant: Hardisty Energy Terminal Limited Partnership, Calgary (CA)

(72) Inventors: ISRAEL MILSTEIN, Los Angeles, CA (US); GEORGE MANI, Calgary (CA)

(21) Appl. No.: 18/176,209

(22) Filed: Feb. 28, 2023

Related U.S. Application Data
(60) Provisional application No. 63/315,389, filed on Mar. 1, 2022.

(51) Int. Cl. C10C 3/00

(52) U.S. Cl. CPC C10C 3/007

(57) ABSTRACT

A process and process line is provided for the removal of a hydrocarbon diluent such as naphtha from hydrocarbon diluent diluted bitumen (“dilbit”) to produce a high viscosity non-hazardous bitumen product for transport, for example, in a railcar, tanker ship or barge. In particular, dilbit is fed into a fractionator having a plurality of steam stripping trays and is evenly distributed along the surface of the trays to increase the surface contact between the steam and dilbit. Steam is introduced below the trays such that the steam flows upward and counter-currently contacts the dilbit distributed on the trays to strip the diluent therefrom and produce the high viscosity non-hazardous bitumen product suitable for transport, for example, in railcars.

### TECHNICAL FIELD

The following relates generally to a process and process line for the removal of a hydrocarbon diluent such as naphtha from hydrocarbon diluent diluted bitumen (“dilbit”) to produce a high viscosity non-hazardous bitumen product for transport in, for example, a railcar, tanker ship and barge. In particular, dilbit is fed into a fractionator having a plurality of steam stripping trays and is evenly distributed along the surface of the trays to increase the surface contact between the steam and dilbit. Steam is introduced below the trays such that the steam flows upward and counter-currently contacts the dilbit distributed on the trays to strip the diluent therefrom and produce the high viscosity non-hazardous bitumen product suitable for transport in, for example, railcars.

### BACKGROUND

Bitumen and heavy oils are often produced from remote deposits such as the Athabasca oil sands in Alberta, Canada. Bitumen is a low-grade crude oil that is composed of complex, heavy hydrocarbons. Because bitumen is very dense and viscous, it is generally too thick to flow in a pipeline at ground temperature. Hence, it must be diluted or “thinned” with a fluid that has a much lower viscosity such as a very light petroleum product called diluent in order to be transported to refineries by pipeline for further upgrading. The most common diluent used in the industry is a natural gas condensate (NGC), especially the naphtha component. The resultant, thinned product is commonly referred to as diluted bitumen or “dilbit”. Generally, dilbit consists of about 25% to 55% diluent by volume, depending on the characteristics of the bitumen and diluent, pipeline specifications, operating conditions, and refinery requirements.

There may be instances, due to a shortage of pipeline capacity, when it is desirable to transport bitumen for further upgrading using a combination of pipelines and rail. However, to transport dilbit by railcar it must be classified as a hazardous substance which means that there may be restrictions including, but not limited to, the need for pressurized rail cars; reduced speed limits; and routing to avoid populated areas. As a result, costs for transporting dilbit can be much higher than transporting a non-hazardous substance. To avoid that designation, a key specification required for any material is a flashpoint of >93° C. In order to accomplish this for dilbit, the diluent must be removed to produce a heavy fraction of bitumen suitable for non-hazardous railcar transport. The recovered light fraction (recycled diluent) can be reused.

Generally, the diluent is separated from the dilbit using a process that incorporates a simple distillation unit that uses heat to separate dilbit into its core components, namely, undiluted bitumen and diluent. However, there are challenges in operating such a distillation unit, in particular, in achieving the specified flashpoint of greater than about 93° C., preferably, greater than 99° C., that is required to produce the desired non-hazardous undiluted bitumen product and recover the diluent for reuse. Thus, there is a need in the industry for a diluent recovery unit and process to achieve the desired flash point.

### SUMMARY

The present invention relates generally to the removal of a diluent such as naphtha from diluent diluted bitumen (dilbit). In particular, a process and process line is provided for the removal of diluent from diluent diluted bitumen to produce a crude bitumen product that is suitable for non-hazardous transportation by, for example, railcar, tanker ship and barge.

In one aspect, a process is provided for producing a high viscosity non-hazardous bitumen product, suitable for non-hazardous transportation, from a hydrocarbon diluent diluted bitumen (dilbit), comprising:
introducing the hydrocarbon diluent diluted bitumen (dilbit) into a fractionator operated at a pressure of about 120 kPa to about 450 kPa and a temperature of about 248° C. to about 272° C., the fractionator having a plurality of interior, vertically spaced stripping trays, and distributing the dilbit over the stripping trays;
introducing steam below the stripping trays for vaporizing/stripping a portion of the hydrocarbon diluent from the dilbit to produce a light overhead fraction and a heavy bottoms fraction; and
removing the heavy bottoms fraction from the fractionator and forming the high viscosity non-hazardous bitumen product from at least a portion of the heavy bottoms fraction.

In one embodiment, the process further comprises transporting the high viscosity non-hazardous bitumen product in a railcar to an upgrading facility for further upgrading.

In one embodiment, the hydrocarbon diluent diluted bitumen (dilbit) is first heated to a temperature of about 248° C. to 272° C. prior to introducing the dilbit into the fractionator.

In one embodiment, the light overhead fraction comprises C₁ to C₇ hydrocarbons. In one embodiment, the heavy bottoms fraction comprises C₆-C₇₊ hydrocarbons and a portion of the hydrocarbon diluent with a flashpoint of greater than 93° C. In one embodiment, the heavy bottoms fraction has a flashpoint of greater than 99° C. to accommodate any tolerances in testing and ensure the flashpoint does not drop below the required 93° C.

In one embodiment, the hydrocarbon diluent is naphtha. In one embodiment, the the light overhead fraction is further processed to remove water and form a recycled diluent for reuse.

### BRIEF DESCRIPTION OF THE DRAWINGS

The invention will now be described by way of an exemplary embodiment with reference to the accompanying simplified, diagrammatic, not-to-scale drawings:

FIGS. 1A and 1B are schematics, which, combined, illustrate a process and a process line for fractionating a hydrocarbon diluent diluted bitumen (dilbit) crude feed into a light overhead fraction and a heavy bottoms fraction according to one embodiment of the present process.

### DETAILED DESCRIPTION

The detailed description set forth below in connection with the appended drawings is intended as a description of various embodiments of the present process and process line and is not intended to represent the only embodiments contemplated by the inventors. The detailed description includes specific details for the purpose of providing a comprehensive understanding of the present process and process line. However, it will be apparent to those skilled in the art that the present process may be practised without these specific details.

The present process and process line relates generally to the removal of diluent from diluent diluted bitumen (dilbit) to produce a crude bitumen product that is suitable for non-hazardous transportation by railcar.

As previously mentioned, one key challenge of removing diluent from dilbit is providing a fractionator capable of removing the necessary amount of diluent from the dilbit to give a heavy fraction (bitumen) capable of being transported by railcar as a non-hazardous substance.

As used herein, “bitumen” means a dense, highly viscous, petroleum-based hydrocarbon that is found in deposits such as oil sands. Bitumen is defined by the U.S. Geological Survey as an extra-heavy oil with an API gravity less than 10° and a viscosity greater than 10,000 centipoise. It owes its density and viscosity to its chemical composition of mainly large hydrocarbon molecules known as asphaltenes and resins, which are present in lighter oils but are highly concentrated in bitumen.

As used herein, “diluent” means a light hydrocarbon stream, usually natural gas condensate, naphtha or a mix of other light hydrocarbons, which is used to dilute bitumen to reduce its viscosity to meet pipeline viscosity and density specifications.

As used herein, “diluted bitumen” or “dilbit” means bitumen that has been blended (diluted) with a diluent. The dilbit blend ratio may consist of 25% to 55% diluent by volume, depending on characteristics of the bitumen and diluent, pipeline specifications, operating conditions, and refinery requirements

As used herein, “viscosity” means a measure of the resistance of a fluid to flow and is normally measured in centipoise (cP″). For bitumen, the viscosity is often measured in centistokes (cSt) at a wide range of temperatures using viscometers.

As used herein, “flash point” of a liquid is defined as the lowest temperature at which a substance generates a sufficient amount of vapor to form a (vapor/air) mixture that can be ignited (piloted ignition). At that temperature, the vapor pressure of the liquid provides a vapor concentration equal to the lower flammability limit. The flash point of a liquid (usually a petroleum product) is a general indication of the flammability or combustibility of a liquid.

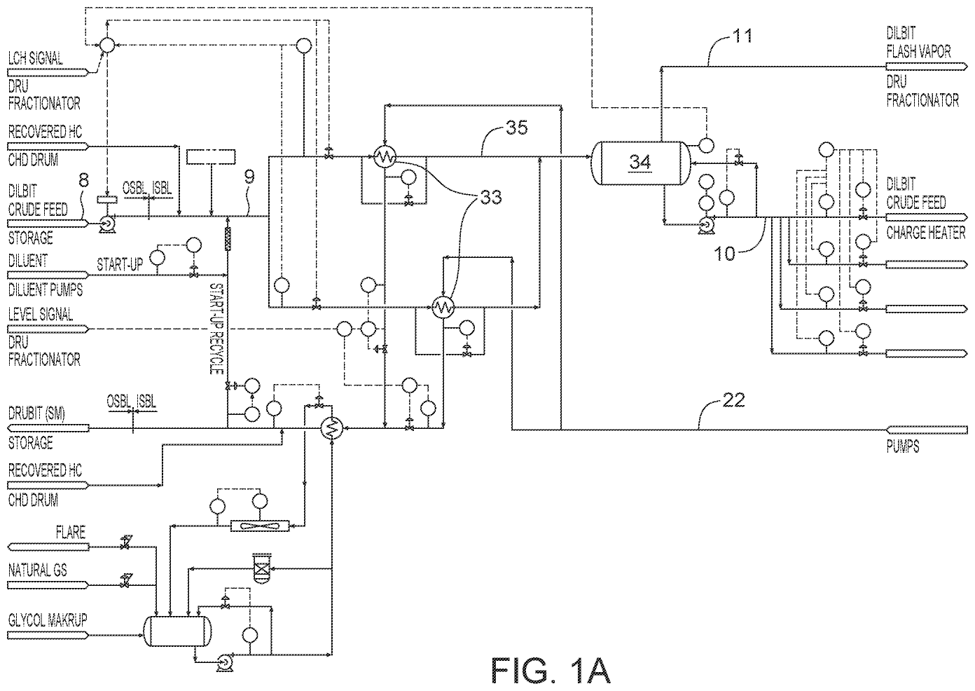

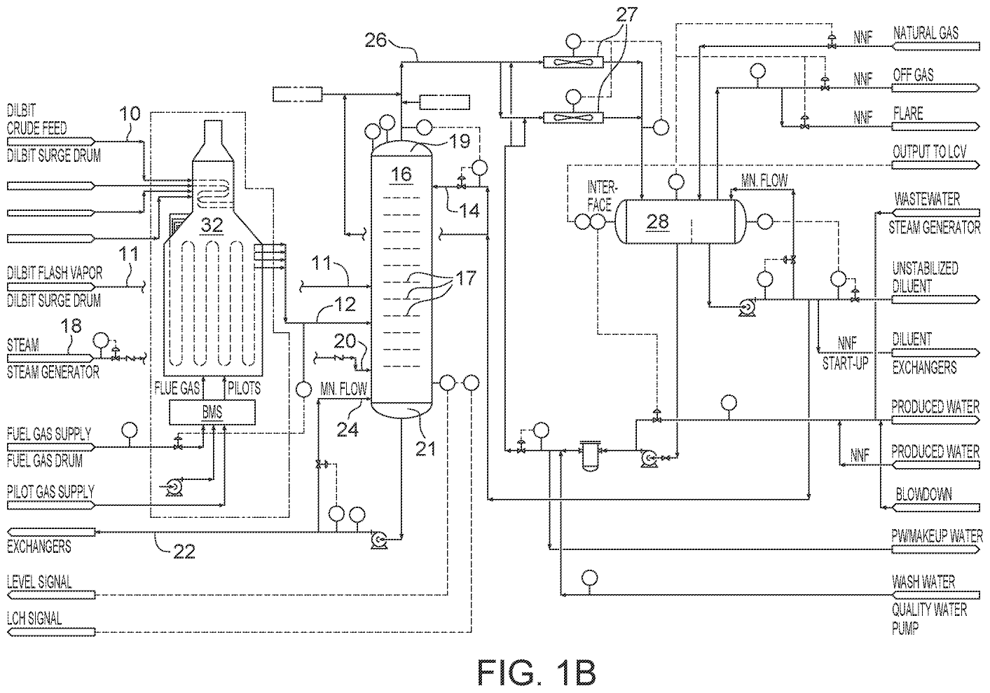

FIGS. 1A and 1B are schematics, which, combined, illustrate a process and a process line for fractionating dilbit crude feed into a light overhead fraction (diluent) generally comprising C₁-C₇ hydrocarbons and a heavy bottoms fraction generally comprising C₆-C₇₊ hydrocarbons and a portion of diluent, resulting in diluent which can be further treated for reuse and a high viscosity non-hazardous bitumen for transport in, for example, a railcar, tanker ship or barge, respectively.

With reference first to FIG. 1A, in this embodiment, the dilbit crude feed 8, which is housed in a dilbit tank or drum (not shown), is pumped via conduit 9 through preheat exchangers 33 and the heated dilbit crude feed then enters pre-flash drum 34 via conduit 35, where part of the diluent is flashed from the dilbit. The remaining hydrocarbon liquid (remaining dilbit) from pre-flash drum 34 is pumped via conduit 10 into charge heater 32, which is shown in FIG. 1B. Charge heater 32 heats the dilbit to a temperature of about 248° C. to about 272° C. prior to the dilbit being introduced into fractionator 16 via dilbit feed conduit 12, which is connected to fractionator 16 via a feed inlet to a feed inlet distributor (not shown) for evenly distributing the dilbit into fractionator 16. The vapour from pre-flash drum 34 is also sent to fractionator 16 via conduit 11.

Referring now to FIG. 1B, in combination with FIG. 1A, fractionator 16 is operated at a temperature of about 248° C. to about 272° C. at the feed inlet and at a pressure of about 120 kPa to about 450 kPa. Directly below the feed inlet distributor, is a chimney tray and a number of steam stripping trays 17 that provide necessary contact surface area for the steam to contact the feed (dilbit). In one embodiment, below the stripping trays 17 is a steam distributor (not shown) connected to a 6″ steam nozzle. Steam 18 is introduced to steam distributor via steam line 20 at a rate of about 1850 kg/hr to about 4000 kg/hr and the steam counter-currently contacts the flashed dilbit that is distributed over stripping trays 17 to remove a portion of the hydrocarbon diluent present in the dilbit as a vapor. The hydrocarbon diluent vapor (also referred to the light overhead fraction) rises to the top of fractionator 16 and the light overhead fraction 18 is removed via light overhead conduit 26 to the fractionator overhead condensers 27 where it is condensed.

The remaining heavy bottoms product 21 that now has a large portion of the diluent stripped therefrom settles to the bottom of fractionator 16 and is removed from fractionator 16 via heavy fraction conduit 22. The heavy bottoms fraction is transported via conduit 22 to heat exchangers 33, where the heavy bottoms is cross-exchanged in the heat exchanger banks 33 with the crude dilbit feed (that enters heat exchangers 33 via conduit 9) and is thereby cooled to about 60° C. to about 75° C. and sent to storage for transportation, for example, in railcars. It is desirable that the heavy bottoms fraction has a flash point of about 99° C. to about 110° C. to be classified as a non-hazardous product that can be safely transported by, for example, railcar, tanker ship and barge.

The light overhead fraction, which has been removed from fractionator 16 via diluent line 26 and condensed by fractionator overhead condensers 27, is then transported to VSL-1010 fractionator overhead accumulator 28 where diluent is separated from water. To meet the necessary specifications the recycled diluent is pumped out for further processing.

### Example 1

In the following example, a diluted bitumen (dilbit) having between 22 to 28% volume of diluent having a viscosity of about 350 cSt at the reference temperature (flowing temperature), which viscosity is low enough to allow the dilbit to easily flow through a pipeline, i.e., a density of less than about 940 Kg/M³, was fed into a fractionator having a plurality of steam stripping trays such that the feed was spread evenly across the trays to provide maximum contact between the feed and the steam. The dilbit was fed into the fractionator at a rate of about 335 Sm³/hr. The temperature at the feed inlet was about 255° C. and the fractionator pressure at the top of the fractionator was about 180 Kpag. Steam was added below the feed inlet at a rate of about 1850 Kg/hr to about 2300 Kg/hr to counter-currently contact the dilbit feed and stripped diluent from the dilbit feed to produce a vaporous, light overhead fraction. The operating conditions of the fractionator are summarized in Table 1 below.

TABLE 1
Operating Conditions

| | | | |
|---|---|---|---|
| Feed Rate | 335 | Sm³/Hr | 22 to 28% |
| | | | Volume Diluent |
| Fractionator Inlet Temp | 255 | ° C. | |
| Fractionator Top | 180 | Kpag | |
| Pressure | | | |
| Steam Flow Rate | 1850 to 2300 | Kg/Hr | |
| Heavy Bottoms | | | |
| Flash Point | 99 to 110 | ° C. | |
| Viscosity | 350 to 500 | cSt at | |
| | | 65° C. | |

As can be seen from Table 1, under these conditions, the heavy bottoms fraction had a flash point of about 99° C. to about 110° C., which is now suitable for transport in railcars, i.e., non-hazardous, having a viscosity of about 350 to about 500 cSt at 65° C.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. A process for producing a high viscosity non-hazardous bitumen product, suitable for non-hazardous transportation, from a hydrocarbon diluent diluted bitumen (dilbit), comprising:
(a) introducing the hydrocarbon diluent diluted bitumen (dilbit) into a fractionator operated at a pressure of about 120 kPa to about 450 kPa and a temperature of about 248° C. to about 272° C., the fractionator having a plurality of interior, vertically spaced stripping trays, and distributing the dilbit over said stripping trays;
(b) introducing steam below the stripping trays for vaporizing/stripping a portion of the hydrocarbon diluent from the dilbit to produce a light overhead fraction and a heavy bottoms fraction; and
(c) removing the heavy bottoms fraction from the fractionator and forming the high viscosity non-hazardous bitumen product from at least a portion of the heavy bottoms fraction.

2. The process as claimed in claim 1, further comprising transporting the high viscosity non-hazardous bitumen product in a railcar to an upgrading facility for further upgrading.

3. The process as claimed in claim 1, wherein the steam is introduced into the fractionator at a rate of about 1850 to about 4000 kg/hr.

4. The process as claimed in claim 1, wherein the dilbit is fed into the fractionator at a rate of about 335 Sm3/hr and the steam is introduced into the fractionator at a rate of about 1850 to about 2300 kg/hr.

5. The process as claimed in claim 1, wherein the dilbit is heated in a heater to a temperature of about 248° C. to 272° C. prior to introducing the dilbit into the fractionator.

6. The process as claimed in claim 1, wherein the light overhead fraction comprises C₁ to C₇ hydrocarbons.

7. The process as claimed in claim 1, wherein the heavy bottoms fraction comprises C₆-C₇₊ hydrocarbons and a portion of the hydrocarbon diluent.

8. The process as claimed in claim 1, wherein the heavy bottoms fraction has a flashpoint of greater than 93° C.

9. The process as claimed in claim 1, wherein the heavy bottoms fraction has a flashpoint of greater than 99° C.

10. The process as claimed in claim 1, wherein the heavy bottoms fraction has a flashpoint of between about 99° C. to about 110° C.

11. The process as claimed in claim 1, wherein the heavy bottoms fraction has a viscosity of non-hazardous, having a viscosity of about 350 to about 500 cSt at 65° C.

12. The process of claim 2, wherein the high viscosity non-hazardous bitumen product is cooled to a temperature of about 60° C. to about 75° C. prior to transporting the high viscosity non-hazardous bitumen product in the railcar.

13. The process as claimed in claim 1, wherein the hydrocarbon diluent is naphtha.

14. The process as claimed in claim 1, wherein the light overhead fraction is further processed to remove water and form a recycled diluent for reuse.

15. The process as claimed in claim 14, wherein the light overhead fraction is first condensed in a condenser and the water is removed in an overhead accumulator.
